(19) United States
(12) Patent Application Publication
(10) Pub. No.: US 2001/0032129 A1
(43) Pub. Date: Oct. 18, 2001

(54) Marketing information medium for monitoring and/or rewarding individual marketing efforts and sales system

(76) Inventor: Masayoshi Morimoto, Tokyo (JP)

Correspondence Address: REED SMITH HAZEL & THOMAS LLP, Suite 1400, 3110 Fairvew Park Drive, Falls Church, VA, 22042, US

(21) Appl. No.: 09/750,139

(22) Filed: Dec. 29, 2000

(30) Foreign Application Priority Data
Apr. 5, 2000 (JP) 2000-103771

(51) Int. Cl. G06F 17/60; G06F 15/173

(52) U.S. Cl. 705/14; 709/224

(57) ABSTRACT

A sales system for monitoring and/or rewarding marketing agents' efforts has a plurality of marketing agents, a marketing information medium to which at least one symbol for specifying a marketing agent is attached, a plurality of merchants, and a management control center which carries out data collection services. Whenever a purchase is conducted via one marketing agent, an electronic transaction subsystem is introduced to specify the marketing agent by the medium and to settle accounts between the merchant, the marketing agent, and/or the control center. The subsystem also allocates a series of symbols and/or a communication application in the purchaser's personal computer corresponding to a new route which leads the purchaser to the merchant's URL(s) whenever the purchaser accesses the system via the new route for the first time so that the system can specify the involved marketing agent even in case that the marketing agent's URL is skipped in the subsequent accesses by the purchaser.

### BACKGROUND OF THE INVENTION

1. Field of the Invention

This invention relates to a marketing information medium for monitoring and/or rewarding individual marketing agents' efforts in a distribution process of merchandise sales as well as to a merchandise sales system using this information medium.

2. Description of the Prior Art

Merchants usually widely distribute at least one kind of marketing information medium in the form of advertisements, such as ‘flyers’ or specifications to encourage more purchases. The problem here involves the activity of the wide distribution of the above information medium. In many cases this information medium is entrusted to middle men, namely, marketing agents, in the distribution process of the merchandise. For instance, ‘flyers’ for marketing a ‘bazaar’ are allowed to be placed in a plurality of restaurants or cafes such as “noodles shops.”

This invention includes such middle-man ‘services’, i.e., placing flyers for distribution service in “noodles shops” or “rice shops”, etc. The problem here is that it is hard to determine whether those middle men actively deliver the information, such as ‘flyers,’ so as to cooperate with the sales effort or they acted negatively, and it is even more difficult to proportionally reward the middle men according to their actual marketing efforts. There is a need to determine the middle men's marketing efforts and to reward them accordingly.

However, in the case that the marketing medium are accessed through URLs, a purchaser's may access a merchant's page via one or more middle men's pages for the first time but later on access to the same merchant's page via the ‘favorite’ feature under any internet browsers, such as Internet Explorer or Netscape. Texts or image files which have been displayed by Internet Explorer and used in a home page, however, are temporarily stored in a hard disc. This is referred to as a temporary internet file and because of this file the home page which has once been displayed can be instantly displayed from the next access. That is to say, by increasing the amount of this instant access the number of home pages which can be displayed at a high speed can be increased and this is generally referred to by the commonly known name of ‘favorites’ which is a conventional means now compiled and utilized by a large number of users.

Most internet browsers have a number of setting items and these setting items can be freely changed by the purchasers themselves. When favorite home pages are added, by any means, to the ‘favorites’ button the time and effort for inputting URLs can be omitted to make the access to the home pages very easy. As such the purchaser may skip any marketing agents' pages correspond to respective middle men and get to the merchant's pages directly. In this case, there is the problem that the middle men cannot be specified, much less can be rewarded.

### SUMMARY OF THE INVENTION

In view of the disadvantages and shortcomings present in the prior art, a general object of the present invention is to provide a marketing information medium which can specify the middle men in the distribution process of the merchandise, to reward, which is referred to as a so-called pay back, the middle men by counting the degree of cooperation distributed amount, that is to say, the amount of inquiries from the purchasers, total sum of the payment by all of these purchasers of the specified middle men or to allow the system to automatically make an electronic transfer of any pay back to the respective accounts of the middle men.

Such pay back can be given in a form of so-called ‘overseas trip.’

According to one aspect of the invention, the utilization of a marketing information medium to which a symbol for specifying each middle man, such as a bar code or an access symbol of a computer, is attached. Accordingly, when this symbol is read out each middle man can be specified.

According to a more specific aspect of the invention, a management center is provided in the distribution process which uses the above described information medium. This management center may, of course, be a service carried out by human beings or a mechanical automated service system.

According to another specific aspect of the invention, an electronic transaction subsystem is provided for evaluating the above described degree of cooperation of each middle man, and for calculating the amount of money to be appropriated to the middle men during the constant period, for budgeting amounts of reward, for informing each middle man of his/her rewards, and/or for directly transferring the pay back to his/her bank account.

According to another aspect of the invention, even in the case that the consumers who use the above described sales system use the means of ‘favorites,’ the numbers and values of purchases can be appropriate to all the middle men of the URLs. To achieve such a feature, the consumers are led to allocate specific symbols numerals and/or letters of the English alphabet for the communication applications of the consumers personal computers at the time of the first access and to register them in the consumers personal computers.

Accordingly, these symbols codes include information corresponding to the middle men of the URLs so that the all the middle men can be specified by detecting and recording from the consumer's personal computer all the middle men's codes.

According to another specific aspect of the invention, the program which reads out each code corresponding to each middle man's URLs is provided in the top page of the first access program. Accordingly, even in the case that any middle man's page is skipped for the second access, the middle man can be specified through the symbol code from the consumer.

### BRIEF DESCRIPTION OF THE DRAWINGS

FIG. 1 is a flow chart diagram of one embodiment of the system according to the present invention;

FIG. 2 is an illustrative diagram of a marketing information medium according to the present invention to which a bar code and/or a home page address is filled in;

FIG. 3 is an illustrative diagram of another embodiment of a marketing information medium according to the present invention to which a home page address is filled in; and

FIG. 4 is a block diagram of one embodiment of the system according to the present invention in the case where ‘favorites’ is utilized.

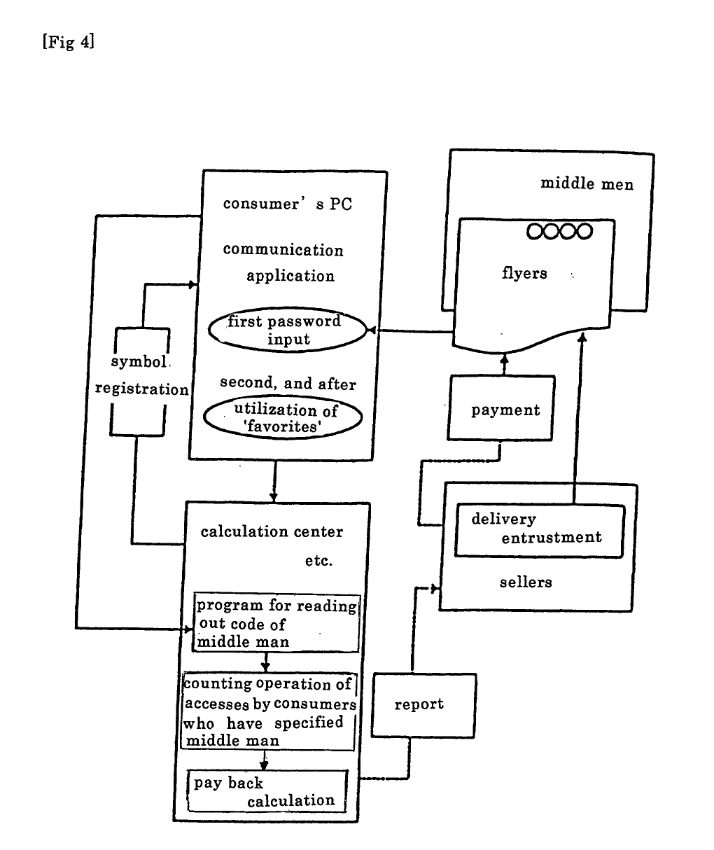

### DETAILED DESCRIPTION OF THE PREFERRED EMBODIMENTS

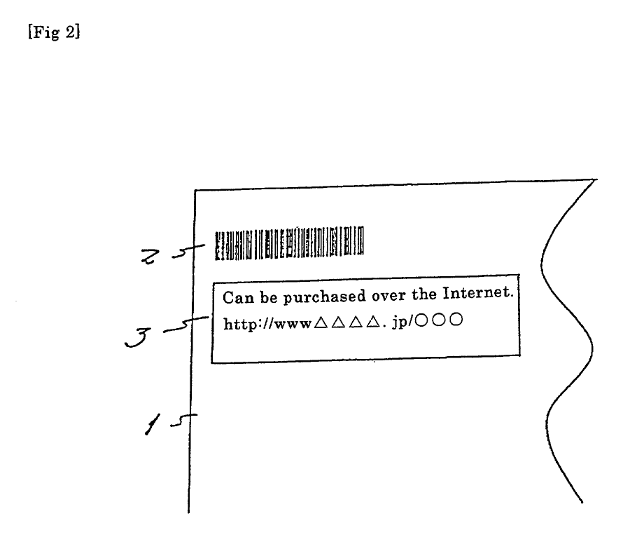

In FIG. 2, a marketing information medium is denoted as 1, which may be any information medium for the merchandise sales or for the offering of services, such as newspapers, magazines, picture postcards, business cards, the handing out of flyers on the street, OEM merchandise such as tissues or hanging advertisements in trains.

Accordingly, in this information medium 1 a bar code 2 which can specify the trademark, the name, or the like, of the middle men who delivers this information medium 1 or cooperates in others ways or the home page address 3 of this merchandise seller is filled in. Naturally, this information medium 1 is delivered by a large number of middle men and, therefore, in the case of the bar code 2 the process is simpler but in the case of the home page address 3 the display is carried out as follows:

middle man A http://wwwΔΔΔΔ.jp/∘∘∘a

middle man B http://wwwΔΔΔΔ.jp/∘∘∘b

•

•

•

middle man Z http://wwwΔΔΔΔ.jp/∘∘∘z

In other words, in the above addresses ΔΔΔΔ specifies the seller, which is the same for all middle men, and the last four digits, for example, are a code which specifies the middle man who delivers the marketing information medium 1 and the seller will require the respective middle men corresponding to the specific code of the last part of the address to deliver the marketing information medium 1.

Now, a purchaser sees the marketing information medium 1 given, for example, from one of these middle men and inputs the home page address into his or her personal computer so as to carry out electronic transaction on the computer or to purchase the merchandise in the marketing information medium 1 by specifying it to the seller and, in the former case, the title or the name of the middle man can be known by reading out the last part of the home page address 3 used in the electronic transaction while, in the latter case, the middle man can be detected by the well known bar code reader.

As a result of this, the seller can offer the corresponding reward to the middle man by calculating the degree of cooperation of the middle man and, thereby, the middle man actively cooperates with the merchandise sales promotion by the seller so that the sales amount of the merchandise can be significantly increased.

When the merchandise shown in the marketing information medium 1, which has been delivered in this way, is accessed through a URL uniform resource locator the purchaser accesses the original page via the middle man's page so that the original home page accessed via this middle man's page detects and counts the middle man. In the case that the purchaser registers it in the above described ‘favorites,’ however, the above middle man's page is skipped and cannot be counted.

Therefore, at the time of the first access by a consumer, a specific symbol is prepared in letters of the English alphabet, numerals, or the combination thereof, with respect to the communication application of this consumer himself/herself so that the operation of registering this in the consumer's personal computer is carried out. In this case, the above specific symbol for each consumer is, of course, different, respectively.

Accordingly, since this symbol code is information of a pre-registered name, title, or the like, which corresponds to the middle man of the URL, even in the case that the consumer skips the middle man's page by utilizing the ‘favorites’ the code for the middle man is acquired from the above code which has been registered in the consumer's personal computer so that the middle man can be specified and the access by the consumer can be counted.

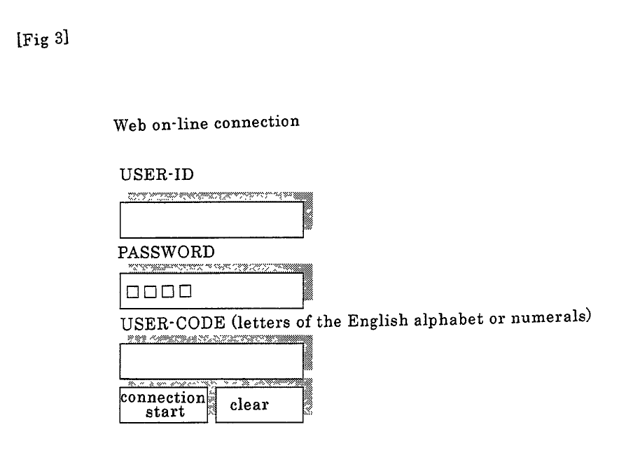

Here, in the case that of the above described home page address, a key word may be attached as shown in FIG. 3.

That is to say, in the above described embodiment, a home page address is filled in into the marketing information medium 1 as [http://wwwΔΔΔ.jp/□□□□□].

Here, in the case that the above home page address is inputted into a computer the display is shown as in FIG. 3. Here, in the case that the numerals of the last part of the above address or the symbol ‘□□□□□’ is inputted 4, that part specifies the middle man so that the trademark or the name can be known.

In addition, in the above described merchandise transaction, the reward which is paid to the middle man is automatically reported to the middle man or an amount of money which is specified in advance by contract can be automatically transferred to the account of the middle man by constructing the management center system.

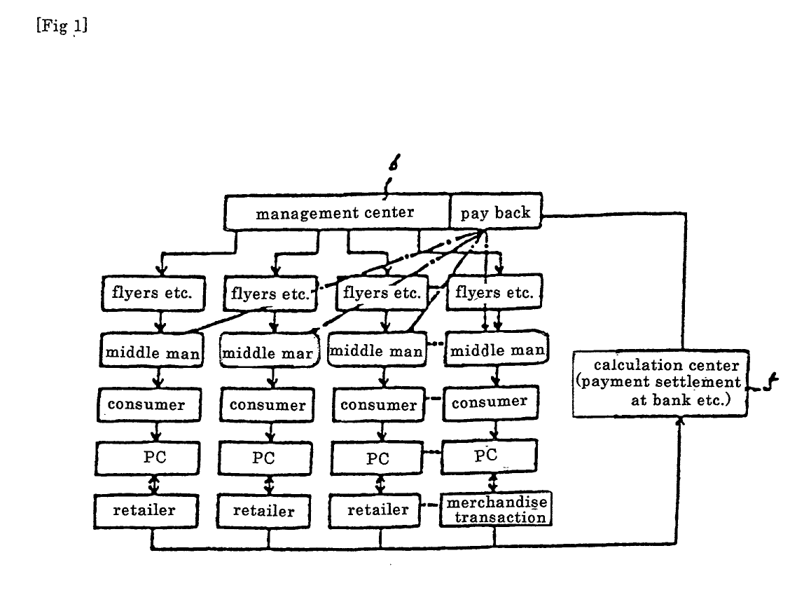

A variety of means can be considered to achieve the above and one example is that the seller conveys the information, such as the trademark or the title of the middle man or the amount of money which has been spent as specified in the above, to a calculation center 5 [a bank in many cases] so that the management center 6 provided in a company, or the like, of the seller accesses this information and conveys it to the middle man as shown in by the chain lines in FIG. 1 or transfers the corresponding amount of money to his or her account.

As described above, according to the present invention, information such as trademark, name or merchandise name of the middle man whom a seller requested to cooperate with the sales of that company's merchandise or the amount of money spent for that can be known so that the corresponding reward can be offered to the middle man and, therefore, an active cooperation from the middle man can be further gained and the sales of the merchandise can be significantly increased.

What is claimed is:

1. A marketing information medium for monitoring and/or rewarding individual marketing agents' efforts is attached of at least one symbol for specifying a marketing agent.

2. A marketing information medium according to claim 1, wherein the symbol is a bar code.

3. A marketing information medium according to claim 1, wherein the symbol is an access code to a computer.

4. A marketing information medium according to claim 1, wherein the symbol is designated to a merchant or a marketing agent.

5. A sales system for monitoring and/or rewarding individual marketing agents' efforts comprising:
a plurality of marketing agents in a distribution process;
a marketing information medium to which at least one symbol for specifying a marketing agent is attached;
a plurality of merchants; and
a management center,
wherein whenever a purchaser purchases at least one merchandise of a merchant via one of the marketing agents, information of that marketing agent is conveyed to the management center.

6. A sales system according to claim 5, wherein said symbol is a bar code.

7. A sales system according to claim 5, wherein said symbol is an access code to a computer.

8. A sales system according to claim 6, wherein said symbol is designated to a merchant or a marketing agent.

9. A sales system for monitoring and/or rewarding individual marketing agents' efforts comprising:
a plurality of marketing agents in a distribution process;
a marketing information medium to which at least one symbol for specifying a marketing agent is attached;
a plurality of merchants; and
a management control center which carries out collection services,
wherein whenever a purchaser purchases at least one merchandise of a merchant via one of the marketing agents, an electronic transaction subsystem is introduced to specify the marketing agent by the medium and to settle accounts between the merchant, the marketing agent, and /or the control center.

10. A sales system according to claim 9, wherein said symbol is a bar code.

11. A sales system according to claim 9, wherein said symbol is an access code to a computer.

12. A sales system according to claim 9, wherein the symbol is designated to a merchant or a marketing agent.

13. A sales system according to claim 9 further including means for the marketing agent to offer information.

14. A sales system according to claim 13, wherein the information is any transactions regarding the purchases.

15. A sales system according to claim 13, wherein in the information is any transacted amount of money.

16. A sales system according to claim 13, wherein the information is the budgeted amount of monetary reward.

17. A sales system according to claim 16, wherein the amount of monetary reward is automatically paid to the account, or the like, of the marketing agent.

18. A sales system for monitoring and/or rewarding individual marketing agents' efforts comprising:
a plurality of marketing agents in a distribution process;
a marketing information medium to which at least one symbol for specifying a marketing agent is attached;
a plurality of merchants; and
a management control center which carries out data collection services,
wherein whenever a purchaser purchases at least one merchandise of a merchant via one of the marketing agents, an electronic transaction subsystem is introduced to specify the marketing agent by the medium and to settle accounts between the merchant, the marketing agent, and/or the control center, and the system allocates a series of symbols and/or a communication application in the purchaser's personal computer corresponding to a new route which leads the purchaser to the merchant's page whenever the purchaser accesses the system via the new route for the first time so that the system can specify the marketing agent even in case that the marketing agent's page is skipped in the subsequent accesses by the purchaser.
